(19) United States
(12) Patent Application Publication
(10) Pub. No.: US 2010/0155978 A1
(43) Pub. Date: Jun. 24, 2010

(54) Biocidal metal-doped materials and articles made therefrom

(76) Inventors: Romain Louis Billiet, Penang (MY); Nguyen Thi Hanh, Penang (MY)

Correspondence Address: ROM L. BILLIET, 26 LORONG SUSU, PENANG, 10400, MY

(21) Appl. No.: 12/621,534

(22) Filed: Nov. 19, 2009

Related U.S. Application Data
(60) Provisional application No. 61/203,047, filed on Dec. 19, 2008.

(51) Int. Cl. A61C 13/00; B28B 1/14

(52) U.S. Cl. 264/16; 264/603; 264/681

(57) ABSTRACT

Inorganic materials doped with biocidal metals are useful for medical devices such as prosthetic implants, heart valves, surgical tools, endoscopes, orthodontics appliances and the like.

### CROSS-REFERENCE TO RELATED APPLICATIONS

This application claims priority to U.S. Provisional Patent Application Ser. No. 61/203,047 filed on Dec. 19, 2008.

### REFERENCES CITED

### U.S. Patent Documents

| | | | |
|---|---|---|---|
| 4,054,139 | October 1977 | Crossley | 128/260 |
| 4,592,920 | June 1986 | Murtfeldt | 427/2 |
| 5,725,817 | March 1998 | Milder | 264/104 |
| 5,783,454 | July 1998 | Spallholz et al. | 436/525 |
| 7,288,264 | October 2007 | Sawan et al. | 424/404 |

### Foreign Patent Documents

| | | | |
|---|---|---|---|
| EP | June 2006 | WO/2006/058906. | IPC A611 27/30 |

### Other Publications

Borkow, G.; Gabbay, J.: “Copper as a Biocidal Tool”—Current Medicinal Chemistry, Vol. 12, No. 18, pp. 2163-75
Mehtar, S.; Wiid, I.; Todorov, S. D.: “The antimicrobial activity of copper and copper alloys against nosocomial pathogens and Mycobacterium tuberculosis isolated from healthcare facilities in the Western Cape: an in-vitro study”—Journal of Hospital Infection, Vol. 68, No. 2, 2008, pp. 45-51
Anonymous: “Copper killer”—The Engineer Online, Technology News. Mar. 28, 2008
Anonymous: “U.S. EPA Approves Registration of Antimicrobial Copper Alloys”—Copper Development Association. Press Release, Mar. 25, 2008
Kuhn, P. J.: “Doorknobs: A Source of Nosocomial Infection?”—Hamot Medical Center. Erie, Pa. Medical Economics Company, Inc., Oradell, N.J. 07649, 1983.
Wilks, S. A.; Michels, H.; Keevil, C. W.: “The Survival of Escherichia coli O157 on a Range of Metal Surfaces”—International Journal of Food Microbiology, Vol. 105, No. 3, December 2005, pp. 445-54
Wilks, S. A.; Michels, H.; Keevil, C. W.: “Survival of Listeria monocytogenes Scott A on metal surfaces: implications for cross-contamination”—International Journal of Food Microbiology, Volume 111, No. 2, September 2006, pp. 93-8
Noyce, J. O.; Michels, H.; Keevil, C. W.: “Inactivation of Influenza A Virus on Copper versus Stainless Steel Surfaces”—Applied and Environmental Microbiology, Vol. 73, No. 8, April 2007, pp. 2748-50
Jing H.; Yu, Z.; Li, L.: “Antibacterial properties and corrosion resistance of Cu and Ag/Cu porous materials”—Journal of Biomedical Materials Research, Vol. 87A, No. 1, 2008, p. 33-37
Gray, J. E.; Norton, P. R.; Alnouno, R.; Marolda, C. L.; Valvano, M. A.; Griffiths, K.: “Biological efficacy of electroless-deposited silver on plasma activated polyurethane”—Biomaterials, Vol. 24, No. 16, July 2003, pp. 2759-65
Ahn, S. J.; Lee, S. J.; Kook, J. K.; Lim, B. S.: “Experimental antimicrobial orthodontic adhesives using nanofillers and silver nanoparticles”—Dental Materials, Vol. 25, Issue 2, February 2009, pp. 206-13
Bjarnsholt, T.; Kirketerp-Moller, K.; Kristiansen, S.; Phipps, R.; Nielsen, A. K.; Jensen, P. O.; Hoiby, N.; Givskov, M.: “Silver against Pseudomonas aeruginosa biofilms”—APMIS, formerly Acta Pathologica, Microbiologica et Immunologica Scandinavica, Vol. 115, No. 8, August 2007, pp. 921-8
Bosetti, M.; Masse, A.; Tobin, E.; Cannas, M.: “Silver coated materials for external fixation devices: in vitro biocompatibility and genotoxicity”—Biomaterials, Vol. 23, No. 3, February 2002, pp. 887-92
Alt, V.; Bechert, T.; Steinrucke, P.; Wagener M.; Seidel, P.; Dingeldein, E.; Domann, E.; Schnettler, R.: “In Vitro Testing of Antimicrobial Activity of Bone Cement”—Antimicrobial Agents and Chemotherapy, Vol. 48, No. 11, November 2004, pp. 4084-8
Das, K.; Bose, S.; Bandyopadhyay, A.; Karandikar, B.; Gibbins, B. L.: “Surface coatings for improvement of bone cell materials and antimicrobial activities of Ti implants”—Journal of Biomedical Materials Research Part B: Applied Biomaterials, Vol. 87B, No. 2, May 2008, pp. 455-60
Verné, E.; Miola, M,; Vitale Brovarone, C.; Cannas, M.; Gatti, S.; Fucale, G.; Maina, G.; Massé, A.; Di Nunzio, S.: “Surface silver-doping of biocompatible glass to induce antibacterial properties. Part I: massive glass”—Journal of Materials Science: Materials in Medecine, November 2008
Ramstedt, M.; Houriet, R.; Mossialos, D.; Haas, D; Mathieu, H. J.: “Wet chemical silver treatment of endotracheal tubes to produce antibacterial surfaces”—Journal of Biomedical Materials Research, Part B, Applied Biomaterials, Vol. 83, No. 1, October 2007, pp. 169-80
Anonymous: “Nanosilver coatings to reduce infection in implanted devices”—Advanced Materials & Processes, Vol. 166, Issue 4, April 2008, p. 46
Roy, R.: “Ultradilute Ag-aquasols with extraordinary bactericidal properties: role of the system Ag—O—H2O”—Materials Research Innovations, Vol. 11, No. 1, 2007, pp. 3-18
Zaporojtchenko, V.; Podschun, R.; Schürmann, U.; Kulkarni, A.; Faupel, F.: “Physico-chemical and antimicrobial properties of co-sputtered Ag—Au/PTFE nanocomposite coatings”—Nanotechnology, Vol. 17, Sep. 11, 2006, pp. 4904-8
Burrell, R.: “Engineering Materials Achievement Award—Nanosilver Wound Dressing”—Advanced Materials & Processes, Vo. 167, Issue 10, October 2009, p. 24
Anonymous: “The Silver Institute—Medical”—The Silver Institute website—http://www.silverinstitute.org
Samuel, E.: “Metal coating provides long-life contact lenses”—NewScientist, 21 Aug. 2002
Tran, P. L.; Hammond, A. A.; Mosley, T.; Cortez, J.; Gray, T.; Colmer-Hamood, J. A.; Shastri, M.; Spallholz, J. E.; Hamood, A. N.; Reid, T. W.: “Organoselenium Coating on Cellulose Inhibits the Formation of Biofilms by Pseudomonas aeruginosa and Staphylococcus aureus”—Applied and Environmental Microbiology, Vol. 75, No. 11, June 2009, pp. 3586-92

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND

1. Field of Invention

The present invention relates to a method for producing inorganic materials having biocidal properties and to apply said materials towards the fabrication of implantable and non-implantable medical devices and other articles, parts, artifacts and accessories susceptible to harbor and or convey pathogenic microorganisms.

2. Description of Prior Art

Pathogenic microorganisms such as bacteria, fungi and viruses are a major cause of serious infectious disease in humans.

For example, tuberculosis, caused by the bacterium Mycobacterium tuberculosis, affects about 2 million people mostly in sub-Saharan Africa. Pneumonia can be caused by bacteria such as Streptococcus and Pseudomonas. Other pathogenic bacteria caused diseases include tetanus, typhoid fever, diphtheria, syphilis and leprosy.

Some notable pathogenic virus families include Picornaviridae such as poliovirus, Herpesviridae such as herpes simplex types 1 and 2 viruses, Flaviviridae such as hepatitis C virus, yellow fever virus, west Nile virus and dengue virus, Retroviridae such the human immunodeficiency virus (HIV), Paramyxoviridae such as measles virus and mumps virus.

One of the better known pathogenic fungi is Candida albicans responsible for vaginal yeast infections.

An alarmingly rising amount of infection by pathogenic microorganisms is taking place in healthcare facilities through direct or indirect contact with contaminated persons or objects such as hospital linen, doorknobs, surgical instruments, biomedical implants, catheters, etc. Hence, efforts are being made in preventing infection by pathogenic microorganisms by focusing on methods to either destroy these pathogens using biocidal agents or to reduce their proliferation.

Biocidal metals have long been known to mankind. Among these copper, silver, gold, zinc and more recently selenium are well known in the prior art.

While the precise biocidal mechanisms of biocidal metals is still the subject of intense research, it is now commonly accepted that they exert their effect by catalyzing the generation of cytotoxic reactive oxygen species such as hydrogen peroxide which disrupt the integrity of the microorganism cell membrane.

Copper has been used for centuries to disinfect liquids, solids and human tissue. Today copper is used as a water purifier, algaecide, fungicide, nematocide, molluscicide, and as an anti-bacterial and anti-fouling agent. Copper also displays potent anti-viral activity yet it is safe to humans, as demonstrated by the widespread and prolonged use of copper intrauterine devices (IUDs) by women. In contrast to the low sensitivity of human tissue (skin or other) to copper, microorganisms are extremely susceptible to copper.

Silver and gold are also well-known biocidal agents. The effect of silver and its salts as an antibacterial agent has long been known, for example salts of silver are used in washing eyes of newborn babies.

More recently it has been discovered that certain selenium compounds are also catalytic when in the presence of endogenous thiols, such as glutathione, which occurs in all aerobic living cells, producing superoxide (O₂⁻), hydrogen peroxide, the hydroxyl radical (^{•}OH) and other cytotoxic reactive oxygen species, i.e. the tissue, cell or bodily fluid itself provides the reducing power for the generation of superoxide.

Most of the known biocidal agents are not suitable by themselves for the direct fabrication of biomedical devices and must therefore be incorporated in coatings. However, coatings may be technically difficult or very expensive to produce or apply. In addition, coatings can be damaged or wear off in cases where there is continuous frictional contact between components of medical devices such as in hip or knee implants or between the medical device and the biological environment in which it is to function, as in the case of blood flow through heart valve prostheses.

Consequently there would be great benefit in having structural materials that are amenable to the fabrication of medical devices which intrinsically contain biocidal agents but which do not suffering from the abovementioned shortcomings of the prior art materials. Also, there would be benefit in having biocidal metal-coated medical devices that do not lose their biocidal properties due to wear. Such materials or devices are currently not found in the market.

### BRIEF SUMMARY OF THE INVENTION

In accordance with the present invention a method is provided to fabricate inorganic materials doped with biocidal metals.

The invention consists of shaping a green body from an intimate dispersion of de-aggregated substantially micrometer-sized particulates of sinterable materials and de-aggregated, substantially micrometer or submicrometer-sized biocidal metal powders in a thermoplastic binder, removing the organic binder from said green body and sintering the binder-free compact.

In a distinct embodiment of the instant invention, a green body is first shaped from a dispersion of said sinterable particulates in said thermoplastic binder but not containing said biocidal metal powders. This green body is then placed in a mold and used as an insert and a biocidal metal powder containing dispersion as described above is molded over the first green part, resulting in a second green body having a dual structure consisting of a biocidal-free core and a biocidal metal-doped case. Binder removal and sintering of such dual structure green part is performed in the same manner as above.

In yet another embodiment of the instant invention, a first green body shaped from a biocidal metal-free molding compound is dewaxed and sintered. The sintered body is then used as an insert of a mold cavity and a biocidal metal powder containing dispersion as described above is molded over the insert, resulting in a second green body having a dual structure consisting of a biocidal-free sintered core coated with a biocidal metal-doped outer stratum in the green state. Binder removal and sintering of such dual structure is conducted in the same manner as above.

### OBJECTS AND ADVANTAGES

It is a primary object of this invention to provide a method to produce inorganic materials doped with biocidal metal powders.

It is another object of this invention to provide a manufacturing process for parts from inorganic materials having biocidal properties.

Yet another object of the present invention is to provide a manufacturing process for parts from inorganic materials enrobed by a stratum of biocidal metal-doped inorganic material.

Still another object of the present invention is to provide biocidal properties to interacting interfacial surfaces of parts in frictional contact.

A still further object of the present invention is to provide a method to fabricate implantable medical devices endowed with biocidal properties.

A still further object of the present invention is to provide a method to fabricate a duplex structure consisting of a high density, biocidal metal-free inner core bonded to a biocidal metal-doped outer stratum.

### BRIEF DESCRIPTION OF THE SEVERAL VIEWS OF THE DRAWINGS

Not Applicable

### DETAILED DESCRIPTION OF THE INVENTION

Crossley U.S. Pat. No. 4,054,139 teaches the inclusion of oligodynamic agents such as silver and gold in the polymeric materials used to fabricate urinary tract catheters for the purpose of reducing infection associated with these devices. He uses the term oligodynamic in the sense of ‘effective in small quantities’ and points out that relatively small loadings of silver, e.g. 10% by weight or less are usually sufficient. In particular, Crossley states that a coverage of as little as 1% or less of the total surface area is effective provided it is distributed evenly over the surface of the medical device coming in contact with the pathogenic microorganisms.

Crossley's discovery has been the guiding principle in the course of the development toward the present invention. Integrating Crossley's two dimensional surface coverage value for effectiveness to a three dimensional volume, we deduce that if the biocidal metals take up as little as 10% or less of the entire volume of a body, and provided they are isotropically distributed therein, any external surface of that body will satisfy Crossley's criterion for effectiveness.

Based on this premiss, the instant invention incorporates biocidal metals in inorganic host materials such as stainless steels and ceramics to the amount of 5-20% by volume. The optimized volume occupancy or loading of the biocidal metals in the host material will be dictated empirically, based on practical experience, the particular type and morphology of biocidal metals, the environment in which the biocidal metal-doped medical device is to perform and the specificity of the pathogenic organisms.

While the specific embodiments of the invention will be elucidated mainly through the non-limiting examples given below and involve materials such as stainless steels, oxide ceramics and cemented carbides, the invention also applies to other metals, alloys, ceramics, cermets, and other sinterable materials.

### EXAMPLE I

A batch of homogeneous thermoplastic molding feedstock was prepared by dispersing in an organic binder 800 g of gas atomized nominal 3.5 μm Microfine™ grade 316L prealloyed stainless steel powder with a copper content of 0.190% from Sandvik Osprey Ltd., 100 g of ferroselenium grade 60 powder from Asarco LLC, 50 g of ultrafine vacuum evaporated 0.1 μm CNT grade nanocopper powder from Canano Technologies LLC and 50 g of ultrafine vacuum evaporated 0.1 μm CNT grade nanosilver powder also from Canano Technologies LLC.

Following cooling the molding feedstock was pelletized and fed into the hopper of a Sodick Model TR40EH plastics injection molding machine fitted with an 8-cavity molding tool for parts for a laparoscope. Following molding the green parts were dewaxed in the conventional manner and sintered to substantially full density. The sintered parts displayed a uniform metallographic structure and had a biocidal metal content as follows:

| Biocidal Metal | Mass % | Volume % |
|---|---|---|
| Copper | 5.0 | 4.5310 |
| Silver | 5.0 | 3.7442 |
| Selenium | 10.0 | 10.4910 |

Consequently the total biocidal metal content in the sintered parts was 18.7662% by volume.

### EXAMPLE II

A second batch of homogeneous thermoplastic molding feedstock was prepared by dispersing in an organic binder 800 g of gas atomized nominal 3.5 μm Microfine™ grade 316L prealloyed stainless steel powder from Sandvik Osprey Ltd. No additional feedstock ingredients were added, i.e. the only biocidal metal present in this second feedstock was the 0.190% copper content of the prealloyed stainless steel powder.

Following cooling the second molding feedstock was pelletized and fed into the hopper of the same Sodick molding machine used in Example I and still fitted with the same 8-cavity molding tool for laparoscopic parts. Green parts were again dewaxed in the conventional manner and sintered to substantially full density in hydrogen during which the parts shrunk by approximately 15.54% linear as a result of the 1.184 shrinkage factor of the second molding feedstock.

A sintered part was then appropriately fitted into each of the eight cavities of the molding tool and used as a mold insert whereupon the molding feedstock from Example I was injected into the insert-containing cavities. The resulting insert-molded green parts were dewaxed and sintered to susbstantially full density as before, yielding a stratified structure consisting of a substantially biocidal metal-free inner core coated with a biocidal metal-doped outer stratum.

### EXAMPLE III

A batch of homogeneous thermoplastic molding feedstock was prepared by dispersing in an organic binder 890 g of reactive calcined alumina grade A16 SG from Almatis GmbH and 110 g of ultrafine vacuum evaporated 0.1 μm CNT grade nanoselenium powder from Canano Technologies LLC

The resulting feedstock was pelletized and into the hopper of a Sodick Model TR4OEH plastics injection molding machine fitted with an 8-cavity molding tool for orthodontic appliances. Following molding the green parts were dewaxed in the conventional manner and sintered to substantially full density. The sintered parts had a biocidal metal content as follows:

| Biocidal Metal | Mass % | Volume % |
|---|---|---|
| Selenium | 11.0 | 10.0506 |

### EXAMPLE IV

Applying the teachings of Billiet et al., U.S. Pat. No. 6,782,940, interchangeable ceramic mold cavity inserts were produced for the molding tool of Example I. The ceramic cavity inserts were 10% linear smaller than those of the original tool.

Green parts, produced in the reduced cavities from the biocidal-free molding feedstock of Example II, were then fitted inside the original cavities of the molding tool and used as inserts.

The biocidal metal-doped molding feedstock of Example I was then molded over the biocidal metal-free inserts. The resulting insert molded green parts were dewaxed and sintered to substantially full density as before, yielding a dense stratified structure consisting of a biocidal metal-free inner core coated with a biocidal metal-doped outer stratum.

### CONCLUSION, RAMIFICATIONS AND SCOPE

In conclusion, the major advantage of this invention resides in the ability to economically produce inorganic biocidal metal-doped materials and useful commercial articles made from said materials such as but not limited to biomedical implants, non-implantable medical devices, orthodontic appliances and the like.

The practical uses of the present invention are clearly broad in scope and universal in application and attempting to enumerate them all would not materially contribute to the description of this invention.

Although the invention has been described with respect to specific preferred embodiments thereof, many variations and modifications will immediately become apparent to those skilled in the art. It is therefore the intention that the appended claims be interpreted as broadly as possible in view of the prior art to include all such variations and modifications.

We claim as our invention:

1. A method for producing a homogeneous inorganic material having biocidal properties, comprising the steps of:
a. providing at least one sinterable material in particulate form,
b. providing at least one biocidal metal in particulate form in a volume equal to 5-20% of that of said sinterable material,
c. homogeneously dispersing said sinterable material and said biocidal metal in an organic thermoplastic binder to form a moldable compound,
d. shaping a green body from said moldable compound and extracting substantially all of the organic binder from said green body,
f. sintering said binder-free green body.

2. The method of claim 1 wherein said sinterable material or materials are selected from the group of metals and metal alloys, oxides, nitrides, carbides, including cemented carbides, and mixtures thereof.

3. The method of claim 2 wherein the biocidal metal or metals comprise copper, gold, silver, selenium, zinc and mixtures thereof.

4. A method for producing a stratified inorganic structure consisting of an inner core coated with an outer layer of material having biocidal properties, comprising the steps of:
a. providing at least one sinterable material in particulate form,
b. homogeneously dispersing said sinterable material in an organic thermoplastic binder to form a first moldable compound,
c. shaping a green body from said first moldable compound,
d. positioning said green body inside a mold cavity as a mold insert,
e. providing a second, biocidal metal containing moldable compound as in claim 3, wherein the sinterable material is co-sinterable with the sinterable material of said first moldable compound,
f. filling said mold cavity containing said green insert with said second molding compound to form a stratified green body,
g. extracting substantially all of the organic binder from said stratified green body and sintering the binder-free stratified green body.

5. The method of claim 3 wherein said sintered dense article includes but is not limited to an implantable medical device such as a prosthetic hip joint or heart valve or oral endosseous implant.

6. The method of claim 3 wherein said sintered dense article includes but is not limited to a non implantable medical device such as a surgical or laparoscopic tool or instrument.

7. The method of claim 6 wherein said non implantable medical device is an orthodontic appliance.

8. The method of claim 4 wherein said sintered dense article includes but is not limited to an implantable medical device such as a prosthetic hip joint or heart valve or oral endosseous implant.

9. The method of claim 4 wherein said sintered dense article includes but is not limited to a non implantable medical device such as a surgical or laparoscopic tool or instrument.

10. The method of claim 9 wherein said non implantable medical device is an orthodontic appliance.
